(19) United States
(12) Patent Application Publication
(10) Pub. No.: US 2008/0101805 A1
(43) Pub. Date: May 1, 2008

(54) IMAGE FORMING APPARATUS AND CONTROL METHOD THEREOF

(75) Inventor: Ho-Ill HYUN, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/773,664

(22) Filed: Jul. 5, 2007

(30) Foreign Application Priority Data
Oct. 25, 2006 (KR) 2006-103955

(51) Int. Cl. G03G 15/20; G03G 15/00

(52) U.S. Cl. 399/33; 399/69; 399/88

(57) ABSTRACT

An image forming apparatus includes a fixing unit having a fixing roller and a heating roller to fix a toner image on a printing medium and a heater to heat the heating roller, a power supply to supply power to the heater included in the fixing unit along a power supply line, a first switch operable to selectively supply the power from the power supply to the heater, a main controller arranged to control an operation of the first switch to maintain a temperature of the fixing unit within a predetermined fixing temperature range, a second switch operable to open the power supply line between the power supply and the heater, and an auxiliary controller arranged to control an operation of the second switch to open the power supply line if the temperature of the fixing unit is outside the predetermined fixing temperature range.

### CROSS-REFERENCE TO RELATED APPLICATION

This application claims the benefit of Korean Application No. 2006-103955, filed Oct. 25, 2006, in the Korean Intellectual Property Office, the disclosure of which is incorporated herein by reference.

### BACKGROUND OF THE INVENTION

1. Field of the Invention

Aspects of the present invention relate to an image forming apparatus and a control method thereof, and more particularly, to an image forming apparatus which has a fixing unit, and a control method thereof.

2. Description of the Related Art

An image forming apparatus, such as a laser printer, a photocopier, a facsimile machine, and a multifunctional product, fixes toner on a printing medium, such as a sheet of paper, and forms a toner image based on image data. FIG. 1 is a control block diagram of a conventional image forming apparatus 10. As shown in FIG. 1, the image forming apparatus 10 includes a fixing unit 11 which has a fixing roller (not shown) and a heating roller (not shown) which fixes a toner image onto a printing medium, such as a sheet of paper, and a heater (not shown) disposed in the heating roller to heat the heating roller, a power supply 12 which supplies power to the heater, a switch 13 which is switched “on” and “off” to selectively supply power from the power supply 12 to the heater, a driving circuit 14 which drives the switch 13, a temperature detecting and protecting circuit 16 which detects a temperature of the fixing unit 11 and protects the driving circuit 14, and a central processing unit (CPU) 15 which controls the driving circuit 14 to keep the temperature of the fixing unit 11 within a predetermined fixing temperature range. The dotted line in FIG. 1 illustrates a power supply route of power which is transmitted from the power supply 12 through the switch 13 to the fixing unit 11.

Typically, the power supply 12 transmits alternating current (AC) power to the heater, in order to reach a fixing temperature. The switch 13 is generally embodied as a Triac to function with the AC power transmitted from the power supply 12. The driving circuit 14 includes an open collector type transistor to drive the Triac.

Generally, the fixing temperature is very high, and the fixing unit 11 reaches a high temperature in an instant. Thus, the transistor and the Triac may short-circuit due to operational errors. If the transistor or the Triac are short-circuited, it may become hard to control the temperature of the fixing unit 11 and the temperature may drastically rise, causing damage to components and possibly even a fire.

Even if the transistor and the Triac operate in a normal state, operational errors in the CPU 15 may make it very difficult to control the temperature of the fixing unit 11, thereby causing similar problems to the problems caused by a short-circuit, such as damage to components and fires due to uncontrollably high temperature.

To address the problem that the fixing unit 11 may overheat, a thermostat (not shown) may be utilized which has an open segment and which cuts off power if the temperature of the fixing unit 11 rises beyond a predetermined range. However, such a thermostat does not have enough operational sensitivity to prevent damage to components caused by high temperature in advance, even if the operational sensitivity is enough to prevent a fire.

### SUMMARY OF THE INVENTION

Accordingly, an aspect of the present invention provides an image forming apparatus which prevents a fixing unit from being overheated with high reliability and high operational sensitivity. Particularly, an aspect of the present invention provides an image forming apparatus which has an overheating prevention part in addition to a fixing temperature control, and improves reliability when the fixing unit of an image forming apparatus is heated up.

An image forming apparatus according to an aspect of the present invention includes a fixing unit having a fixing roller and a heating roller to fix a toner image on a printing medium and a heater to heat the heating roller, a power supply to supply power to the heater included in the fixing unit along a power supply line, a first switch operable to selectively supply the power from the power supply to the heater a main controller arranged to control an operation of the first switch to maintain a temperature of the fixing unit within a predetermined fixing temperature range, a second switch operable to open the power supply line between the power supply and the heater, and an auxiliary controller arranged to control an operation of the second switch to open the power supply line if the temperature of the fixing unit is outside the predetermined fixing temperature range.

According to an aspect of the present invention, the first switch is a Triac which is connected in series between the power supply and the heater along the power supply line.

According to an aspect of the present invention, the second switch is a relay which is connected in series between the power supply and the heater along the power supply line.

According to an aspect of the present invention, the image forming apparatus further includes a first thermistor which detects the temperature of the fixing unit and supplies the temperature to the main controller, and a second thermistor which detects the temperature of the fixing unit and supplies the temperature to the auxiliary controller.

According to an aspect of the present invention, the auxiliary controller includes resistors connected to the auxiliary controller at respective connection points, and a comparator which compares voltages at the connection points of the resistors and outputs a control signal to the relay indicating whether to open the power supply line depending on a result of the comparison between the voltages.

The foregoing and/or other aspects of the present invention can be achieved by a method of controlling an image forming apparatus having a fixing unit which has a fixing roller and a heating roller to fix a toner image on a printing medium, a heater to heat the heating roller, and a power supply to supply power to the heater, the method including detecting a temperature of the fixing unit; selectively supplying the power along a power supply line from the power supply to the heater to maintain the temperature of the fixing unit within a predetermined temperature range; and opening the power supply line to stop supplying the power from the power supply to the heater, if the temperature of the fixing unit exceeds the predetermined temperature range using a second switch.

According to another aspect of the present invention, a Triac is disposed on the power supply line between the power supply and the heater, and the selective supplying of the power includes switching on and off the Triac.

According to another aspect of the present invention, a relay is disposed on the power supply line between the power supply and the heater, and the opening of the power supply line includes switching on and off the relay.

According to another aspect of the present invention, the detecting of the temperature of the fixing unit includes detecting the temperature of the fixing unit using a first thermistor provided in the fixing unit to detect the temperature of the fixing unit and a second thermistor provided in the fixing unit to detect the temperature of the fixing unit.

According to another aspect of the present invention, the selective supplying of the power from the power supply to the heater includes determining whether the temperature of the fixing unit detected by the first thermistor is within the predetermined temperature range, and supplying the power if the temperature of the fixing unit is within the predetermined temperature range.

According to another aspect of the present invention, the opening of the power supply line between the power supply and the heater includes determining whether the temperature of the fixing unit detected by the second thermistor exceeds the predetermined temperature range, and opening the power supply line if the temperature of the fixing unit exceeds the predetermined temperature range.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional image forming apparatus;

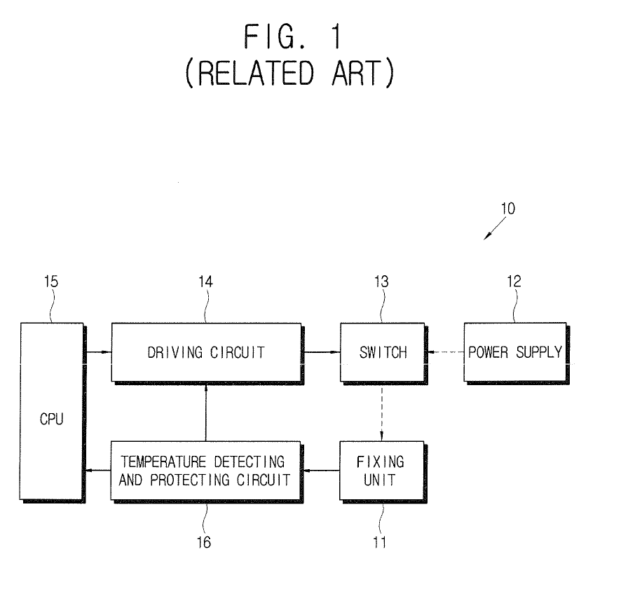

FIG. 2 is a block diagram of an image forming apparatus according to an example embodiment of the present invention;

FIG. 3 is a circuit diagram of a temperature detecting and protecting circuit and a driving circuit of the image forming apparatus shown in FIG. 2;

FIG. 4 is a circuit diagram of a cutoff circuit of the image forming apparatus shown in FIG. 2; and

FIG. 5 is a circuit diagram of a first switch and a second switch of the image forming apparatus shown in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

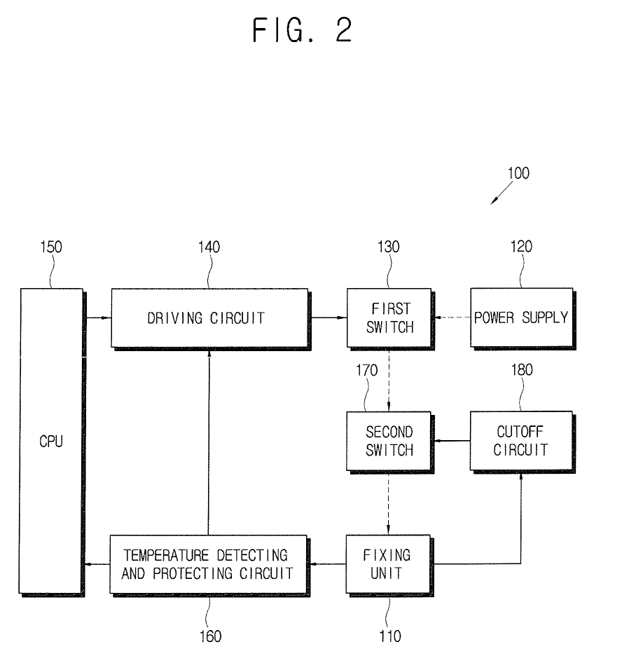

FIG. 2 is a block diagram illustrating a configuration of an image forming apparatus 100 according to an example embodiment of the present invention. The image forming apparatus 100 may include a laser printer, a photo-copier, a facsimile machine, and a multi-function product. As shown in FIG. 2, the image forming apparatus 100 includes a fixing unit 110, a power supply 120, a first switch 130, a driving circuit 140, a CPU 150, a second switch 170 and a cutoff circuit 180. It is understood that the image forming apparatus has many other components in addition to those listed above.

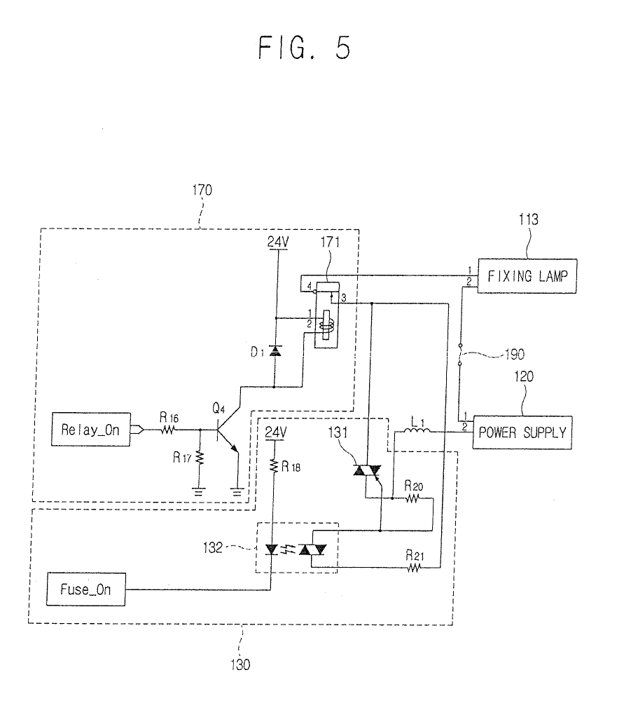

The fixing unit 110 includes a fixing roller (not shown) and a heating roller (not shown) which jointly operate to fix toner onto a printing medium such as a sheet of paper, a transparency sheet, etc., and a heater (not shown) which heats the heating roller. The heater may employ a fixing lamp 113 (FIG. 5) or an instant-on fuser.

The power supply 120 supplies AC power to the heater included in the fixing unit 110. The power supply 120 may be realized by a switched mode power supply (SMPS). The dotted line in FIG. 2 illustrates a power supply route of power transmitted from the power supply 120 to the fixing unit 110. The first switch 130 switches on and off to selectively supply power from the power supply 120 to the heater. The first switch 130 may be realized by a TRIAC, which is a type of switch that is designed to be used with AC power. The CPU 150 controls the driving circuit 140, which drives the first switch 130. It is understood that the first switch 130 is not limited to being a TRIAC, and may instead be many other types of switches, such as a DIAC, etc.

The CPU 150 controls the driving circuit 140 so that a temperature of the fixing unit 110 stays within a predetermined fixing temperature range. The image forming apparatus 100 may further include a temperature detecting and protecting circuit 160 which detects a temperature of the fixing unit 110 and supplies temperature information to the CPU 150. If the detected temperature is higher than a predetermined value, the temperature detecting and protecting circuit 160 controls the first switch 130 to be switched off, thereby assisting the CPU 150 in controlling a temperature of the fixing unit 110. The CPU is also referred to as a main controller.

The second switch 170 selectively opens a power supply line between the power supply 120 and the heater. The cutoff circuit 180 controls the second switch 170 to open the power supply line if the temperature of the fixing unit 110 is above the fixing temperature range. When the power supply line is opened, the power supply 120 cannot supply the heater included in the fixing unit 110 with power. The second switch 170 may be embodied as a relay 171 (shown in FIG. 5) which is connected in series with the power supply line between the power supply 120 and the heater. The cutoff circuit 180 is also referred to as an auxiliary controller.

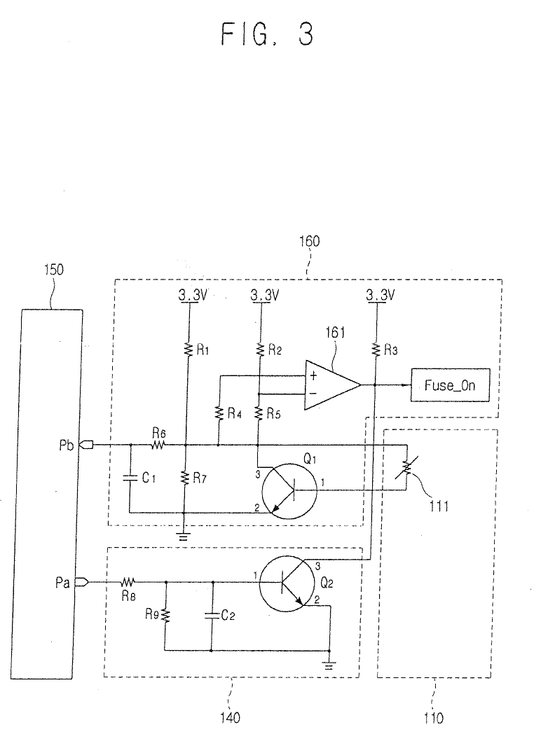

FIG. 3 is a circuit diagram of the temperature detecting and protecting circuit 160 and the driving circuit 140 shown in FIG. 2. As shown in FIG. 3, the temperature detecting and protecting circuit 160 includes a first resistor R1, second resistor R2, third resistor R3, fourth resistor R4, fifth resistor R5, sixth resistor R6 and seventh resistor R7, a first capacitor C1, a first transistor Q1 and a first comparator 161. A first thermistor 111 is further provided in the fixing unit 110, and has a resistance value that varies according to the temperature of the fixing unit 110. The first thermistor 111 is connected to the seventh resistor R7 in parallel. The first capacitor C1 is used as a noise removing filter.

The driving circuit 140 includes an eighth resistor R8, a ninth resistor R9, a second capacitor C2 and a second transistor Q2. The CPU 150 controls the driving circuit 140 by transmitting a control signal Pa through the eighth resistor R8 to the driving circuit 140. The second transistor Q2 is turned “on” and “off” by the control signal Pa, and turning “on” and “off” the second transistor Q2 determines the state of a driving signal Fuse_on supplied to the first switch 130. If the control signal Pa is in a low state, the second transistor Q2 is turned “off” to make the driving signal Fuse_on high. If the driving signal Fuse_on is in a high state, power is not supplied to the heater, i.e., power is cut off. If the control signal Pa is in a high state, the second transistor Q2 is turned “on” to make the driving signal Fuse_on low. If the driving signal Fuse_on is in a low state, power is supplied to the heater included in the fixing unit 110.

The CPU 150 receives temperature information Pb of the fixing unit 110 through the sixth resistor R6, the temperature information corresponding to a resistance value of the first thermistor 111. The CPU 150 determines the temperature information Pb by a voltage value. Based on the temperature information Pb, the CPU 150 outputs the control signal Pa so that the voltage value inputted through the sixth resistor R6 is within a predetermined voltage value range corresponding to the fixing temperature range.

If the fixing unit 110 is overheated to the point where the resistance value of the first thermistor 111 exceeds a predetermined value, a voltage value inputted to the first comparator 161 through the fourth resistor R4 becomes larger than the voltage value inputted to the first comparator 161 through the fifth resistor R5. Then, an output signal of the first comparator 161 becomes high and the driving signal Fuse_on also becomes high, regardless of the control signal Pa of the CPU 150, thereby cutting off power to the heater. The resistance values of the first resistor R1, the second resistor R2, the third resistor R3, the fourth resistor R4, the fifth resistor R5, the sixth resistor R6 and the seventh resistor R7 may be adjusted to make the output signal of the first comparator 161 high if the temperature of the fixing unit 110 exceeds the fixing temperature range.

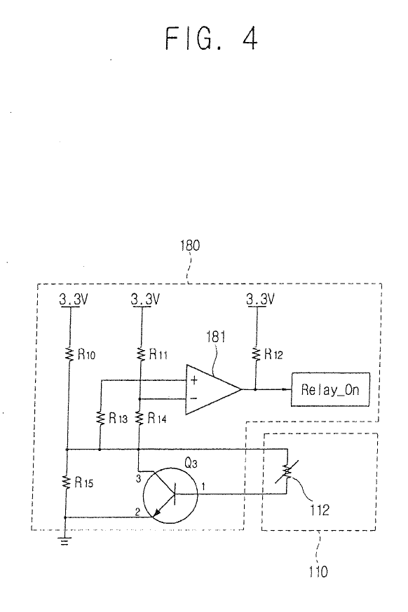

FIG. 4 is a circuit diagram of the cutoff circuit 180 shown in FIG. 2. The cutoff circuit 180 includes a tenth resistor R10, eleventh resistor R11, twelfth resistor R12, thirteenth resistor R13, fourteenth resistor R14, and fifteenth resistor R15, a third transistor Q3 and a second comparator 181. A second thermistor 112 is further provided in the fixing unit 110, and has a resistance value varying according to the temperature of the fixing unit 110. The second thermistor 112 is connected to the fifteenth resistor R15 in parallel.

If the fixing unit 110 is overheated to the point where the resistance value of the second thermistor 112 exceeds an upper limit of the fixing temperature range, a voltage value inputted to the second comparator 181 through the thirteenth resistor R13 becomes larger than a voltage value inputted to the second comparator 181 through the fourteenth resistor R14. The thirteenth resistor R13 and the fourteenth resistor R14 each connect to the cutoff circuit 180 at connection points, where the voltage values are measured. In this case, a cutoff signal Relay_on, which is an output signal of the second comparator 181, becomes high. The resistance values of the tenth resistor R10, eleventh resistor R11, twelfth resistor R12, thirteenth resistor R13, fourteenth resistor R14 and fifteenth resistor R15 may be adjusted to make the output signal of the second comparator 181 high if the temperature of the fixing unit 110 is approximately 5° C. higher than the value of an upper limit of the fixing temperature range. It is understood that the temperature may be adjusted to be more or less than approximately 5° C. higher than the value of an upper limit of the fixing temperature range. If the cutoff signal Relay_on is in a high state, the power supply line between the power supply 120 and the heater is opened to cut off power to the heater.

FIG. 5 is a circuit diagram of the first switch 130 and the second switch 170 shown in FIG. 2. A fixing lamp 113 is further provided in the fixing unit 110 to generate heat. An inductor L1 is connected in series with a power supply line between the fixing lamp 113 and the power supply 120, and a fuse 190 is provided to cut off the power supply line to protect the circuit when a current value becomes too large. Also, although FIG. 5 depicts a first switch 130 and a second switch 170, it is understood that more than two switches may be used according to other aspects of the present invention.

The first switch 130 includes a Triac 131 which is connected in series with the power supply line that supplies power to the fixing lamp 113, a photocoupler 132 which relays a driving signal Fuse_on from the driving circuit 140 to a gate of the Triac 131, and a group of resistors including an eighteenth resistor R18, a twentieth resistor R20 and a twenty-first resistor R21 which are connected to the photocoupler 132.

If the driving signal Fuse_on of the driving circuit 140 is in a low state, the photocoupler 132 is turned “on” so as to turn “on” the Triac 131. When the photocoupler 132 turns “on” the Triac 131, a current flows in a loop through the power supply 120, the fuse 190, the fixing lamp 113, the relay 171, the Triac 131 and the inductor L1, thereby raising the temperature of the fixing lamp 113. Conversely, if the driving signal Fuse_on of the driving circuit 140 is in a high state, the photocoupler 132 is turned “off” so as to turn “off” the Triac 131. When the Triac 131 is turned “off”, power from the power supply 120 is not supplied to the fixing lamp 113.

The second switch 170 includes the relay 171 which is connected in series with the power supply line of the fixing lamp 113, a fourth transistor Q4 which relays the cutoff signal Relay_on from the cutoff circuit 180 to the relay 171, a sixteenth resistor R16 and a seventeenth resistor R17 which are connected to the fourth transistor Q4, and a diode D1 which prevents counter electromotive force (CEMF).

If the cutoff signal Relay_on of the cutoff circuit 180 is in a low state, the fourth transistor Q4 is turned “off” and the relay 171 remains in a turn-on state. Thus, a current flows in the power supply line of the fixing lamp 113 to supply power thereto. Conversely, if the cutoff signal Relay_on of the cutoff circuit 180 is in a high state, the fourth transistor Q4 is turned “on” to turn “off” the relay 171. Then, the power supply line of the fixing lamp 113 is opened to cut off power to the fixing lamp 113.

As described above, aspects of the present invention provide an image forming apparatus which has overheating prevention measures that are separate from a fixing temperature controller and prevent a fixing unit from being overheated with high reliability, and a control method thereof. Particularly, the image forming apparatus according to aspects of the present invention employs a relay as a separate overheating prevention measure which blocks physical and electrical connections, instead of relying on a single switching element such as a Triac which controls the amount of a current, thereby protecting the fixing unit from overheating in an effective fashion and preventing fires. While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the temperature detecting and protecting circuit 160 (FIG. 3), the driving circuit 140 (FIG. 3), and the cutoff circuit 180 (FIG. 4) may each be designed in a different configuration than those shown in FIGS. 3 and 4 and described above. Moreover, the image forming apparatus according to aspects of the present invention is not limited to employing two switches, and may instead employ three or more switches which protect the fixing unit 110 from overheating. Accordingly, it is intended, therefore, that the present invention not be limited to the various example embodiments disclosed, but that the present invention includes all embodiments falling within the scope of the appended claims.

What is claimed is:

1. An image forming apparatus comprising:
a fixing unit having a fixing roller and a heating roller to fix a toner image on a printing medium and a heater to heat the heating roller;
a power supply to supply power to the heater included in the fixing unit along a power supply line;
a first switch operable to selectively supply the power from the power supply to the heater;
a main controller arranged to control an operation of the first switch to maintain a temperature of the fixing unit within a predetermined fixing temperature range;
a second switch operable to open the power supply line between the power supply and the heater; and
an auxiliary controller arranged to control an operation of the second switch to open the power supply line if the temperature of the fixing unit is outside the predetermined fixing temperature range.

2. The image forming apparatus according to claim 1, wherein the first switch comprises a Triac which is connected in series between the power supply and the heater along the power supply line.

3. The image forming apparatus according to claim 1, wherein the second switch comprises a relay which is connected in series between the power supply and the heater along the power supply line.

4. The image forming apparatus according to claim 1, further comprising:
a first thermistor which detects the temperature of the fixing unit and supplies the temperature to the main controller; and
a second thermistor which detects the temperature of the fixing unit and supplies the temperature to the auxiliary controller.

5. The image forming apparatus according to claim 3, wherein the auxiliary controller comprises:
resistors connected to the auxiliary controller at respective connection points; and
a comparator which compares voltages at the connection points of the resistors and outputs a control signal to the relay indicating whether to open the power supply line depending on a result of the comparison between the voltages.

6. A method of controlling an image forming apparatus comprising a fixing unit which has a fixing roller and a heating roller to fix a toner image on a printing medium, a heater to heat the heating roller, and a power supply to supply power to the heater, the method comprising:
detecting a temperature of the fixing unit;
selectively supplying the power along a power supply line from the power supply to the heater to maintain the temperature of the fixing unit within a predetermined temperature range; and
opening the power supply line to stop supplying the power from the power supply to the heater, if the temperature of the fixing unit exceeds the predetermined fixing temperature range.

7. The method according to claim 6, wherein a Triac is disposed on the power supply line between the power supply and the heater, and the selective supplying of the power from the power supply to the heater comprises switching on and off the Triac.

8. The method according to claim 6, wherein a relay is disposed on the power line between the power supply and the heater, and the opening of the power supply line between the power supply and the heater comprises switching on and off the relay.

9. The method according to claim 6, wherein the detecting of the temperature of the fixing unit comprises detecting the temperature of the fixing unit using a first thermistor provided in the fixing unit to detect the temperature of the fixing unit and a second thermistor provided in the fixing unit to detect the temperature of the fixing unit.

10. The method according to claim 9, wherein the selective supplying of the power from the power supply to the heater comprises:
determining whether the temperature of the fixing unit detected by the first thermistor is within the predetermined fixing temperature range, and
supplying the power if the temperature of the fixing unit is within the predetermined fixing temperature range.

11. The method according to claim 9, wherein the opening of the power supply line between the power supply and the heater comprises:
determining whether the temperature of the fixing unit detected by the second thermistor exceeds the predetermined fixing temperature range, and
opening the power supply line if the temperature of the fixing unit exceeds the predetermined fixing temperature range.

12. An image forming apparatus comprising:
a fixing unit having a fixing roller and a heating roller to fix a toner image on a printing medium and a heater to heat the heating roller;
a power supply to supply power along a power supply line to the heater;
a first switch disposed along the power supply line to selectively supply the power to the heater; and
a second switch disposed along the power supply line to cut off the power supply line according to a temperature of the fixing unit.

13. The image forming apparatus according to claim 12, wherein the second switch cuts off the power line by opening a section of the power supply line.

14. The image forming apparatus according to claim 12, wherein if the temperature of the fixing unit is within a predetermined fixing temperature range, the second switch supplies the power to the heater, and if the temperature of the fixing unit is not within the predetermined fixing temperature range, the second switch does not supply the power to the heater.

15. The image forming apparatus according to claim 12, wherein the first switch is disposed next to the power supply along the power supply line, and the second switch is disposed between the first switch and the fixing unit along the power supply line.

16. The image forming apparatus according to claim 12, wherein the first switch comprises:
a TRIAC connected to the power supply line; and
a photocoupler to transmit a driving signal to the TRIAC indicating whether the TRIAC should supply the power to the heater, wherein the driving signal is based on the temperature of the fixing unit.

17. The image forming apparatus according to claim 12, wherein the second switch comprises:
a relay connected to the power supply line; and
a transistor to transmit a cutoff signal to the relay indicating whether the relay should supply the power to the heater, wherein the cutoff signal is based on the temperature of the fixing unit.

18. The image forming apparatus according to claim 16, further comprising:
a first thermistor disposed in the fixing unit to detect the temperature of the fixing unit;
a temperature detecting and protecting circuit connected to the first thermistor to compare the temperature detected by the first thermistor to a predetermined fixing temperature range; and
a driving circuit connected to the temperature detecting and protecting circuit to transmit the driving signal to the photocoupler based on the comparison performed by the temperature detecting and protecting circuit.

19. The image forming apparatus according to claim 17, further comprising:
a second thermistor disposed in the fixing unit to detect the temperature of the fixing unit; and
a cutoff circuit connected to the second thermistor to compare the temperature detected by the second thermistor with a predetermined fixing temperature range and to transmit the cutoff signal to the transistor based on the comparison performed by the cutoff circuit.

20. A method of controlling a fixing unit temperature in an image forming apparatus, comprising:
detecting a temperature of the fixing unit;
selectively supplying power along a power supply line to the fixing unit by operating a first switch; and
cutting off the selective supplying of the power by operating a second switch, wherein the power is cut off according to the detected temperature.

21. The method according to claim 20, wherein if the detected temperature is within a predetermined fixing temperature range, the second switch is operated to supply the power to a heater, and if the detected temperature is not within the predetermined fixing temperature range, the second switch is operated to cut off the power to the heater.

22. The method according to claim 20, wherein the first switch comprises a Triac which is connected on the power supply line between a power supply and a heater, and the second switch comprises a relay which is connected on the power supply line between the power supply and the heater.

23. The method according to claim 20, wherein the first and second switches are each connected to a respective thermister in the fixing unit to detect the temperature of the fixing unit.
